(19) United States
(12) Patent Application Publication
(10) Pub. No.: US 2016/0115008 A1
(43) Pub. Date: Apr. 28, 2016

(54) Containers and Processes for Filling Containers

(71) Applicant: The Coca-Cola Company, Atlanta, GA (US)

(72) Inventor: Jeremie Bohen, Sydney (AU)

(21) Appl. No.: 14/523,371

(22) Filed: Oct. 24, 2014

(51) Int. Cl. B67C 3/22; B65D 1/02; B65B 61/24; B65B 63/08

(52) U.S. Cl. CPC B67C 3/22; B65B 63/08; B65D 1/0223; B65B 61/24; B67C 2003/228; B67C 2003/226

(57) ABSTRACT

A process includes filling a bottle with a liquid at a warm-fill temperature and adding a dose of liquid nitrogen to the liquid in the bottle. The dose of liquid nitrogen is selected to generate an initial pressure. The method further includes capping the bottle with a closure, inverting the bottle, and cooling the bottle after a holding time. The bottle has portion with a non-circular cross-section.

### TECHNICAL FIELD

The present disclosure relates to containers and methods for filling containers.

### BACKGROUND

Conventional container manufacturing has a number of limitations including design constraints that are imposed on the container and/or the high costs of a filling process.

Using a hot-fill technique, a container is filled with hot product that in turn sterilises the container and closure. However, a hot-fill process requires a container to withstand exposure to hot temperatures. A hot-fill process also requires a container to withstand a vacuum that is induced inside the bottle after hot-filling, capping, and cooling the container.

For example, certain containers that designed for hot-filling use a relatively large amount of plastic to provide enough rigidity to prevent shrinkage. The amount of plastic is costly and the design constraints limit the possible number for designs. For example, the design constraints limit certain designs for aesthetic and ergonomic purposes. The aesthetics and ergonomics of a design contribute to beverage sales and customer adoption. The design constraints also limit the use of certain functional features.

Certain of these rigid containers that are designed for hot-filling include flexible panels to respond to the vacuum. Although nitrogen dosing has been used with hot-fill processes to reduce the vacuum that is induced and thus remove the need for flexible panels, nitrogen dosing and the resulting pressure needs to be relatively high to limit bottle shrinkage. This results in design limitations or otherwise introduces new problems when used with the hot-fill process. Moreover, the containers remain costly because of the large amount of plastic.

An aseptic technique fills and caps each bottle in a sterile environment. Aseptic filling processes do not require a container to withstand exposure to hot temperatures or a vacuum. However, aseptic processes require a high capital investment and high operating costs due to the technology involved and lengthy sterilisation processes.

### SUMMARY

The present disclosure provides warm-fill processes and containers that are not subject to limitations associated with hot-fill processes and aseptic filling processes. For example, a warm-fill process fills a container with a shelf-stable sensitive beverage without preservatives.

The warm-fill processes can be used with a container with aesthetic and functional features. For example, the container includes a low profile base and a portion with a non-circular cross-section. In certain embodiments, the container can be squeezed at the non-circular portion to expel the product through a sport closure.

According to an exemplary embodiment, a process includes filling a bottle with a liquid. The liquid is initially at a temperature between about seventy degrees Celsius and seventy seven degrees Celsius. The process further includes adding a dose of liquid nitrogen to the liquid in the bottle. The dose of liquid nitrogen is selected to generate an initial pressure to expand a portion of the bottle having a non-circular cross-section. The portion has a portion length that is at least thirty five percent of a total length of the bottle. The process further includes capping the bottle with a closure, inverting the bottle for a minimum inverting time, and cooling the bottle after a minimum holding time.

According to an exemplary embodiment, the temperature of the liquid is between about seventy two degrees Celsius and seventy four degrees Celsius.

According to an exemplary embodiment, the dose of liquid nitrogen is selected to generate an initial pressure between six pounds per square inch and twenty pounds per square inch.

According to an exemplary embodiment, the dose of liquid nitrogen is selected to generate an initial pressure between six pounds per square inch and seven pounds per square inch.

According to an exemplary embodiment, the minimum inverting time is twenty seconds and the minimum holding time is three hundred seconds.

According to an exemplary embodiment, the non-circular cross-section is oval-shaped, square-shaped, or triangle-shaped.

According to an exemplary embodiment, the portion is configured to expand after the capping step.

According to an exemplary embodiment, the portion is configured to contract during the holding step, the inverting step, and the cooling step.

According to an exemplary embodiment, the portion is configured to expand so as to have a circular cross-section.

According to an exemplary embodiment, a residual pressure of the bottle is approximately zero after the cooling step.

According to an exemplary embodiment, the bottle includes a low profile base or a petaloid base.

According to an exemplary embodiment, the base includes a standing diameter that is greater than seventy percent of an outside diameter of the bottle.

According to an exemplary embodiment, the base includes a standing surface that has an area that is greater than fifty percent of an area defined by an outside diameter of the bottle.

According to an exemplary embodiment, the portion includes a portion surface area that is greater than thirty percent of a bottle surface area of the bottle.

According to an exemplary embodiment, a process includes filling a bottle with a liquid. The liquid is initially at a temperature between about seventy degrees Celsius and seventy seven degrees Celsius. The process further includes adding a dose of liquid nitrogen to the liquid in the bottle. The dose of liquid nitrogen is selected to generate an initial pressure between six pounds per square inch and twenty pounds per square inch. The process further includes capping the bottle with a closure.

According to an exemplary embodiment, the process further includes inverting the bottle for a minimum of twenty seconds and cooling the bottle after a minimum holding time of three hundred seconds.

According to an exemplary embodiment, the temperature of the liquid is between about seventy two degrees Celsius and seventy four degrees Celsius.

According to an exemplary embodiment, the dose of liquid nitrogen is selected to generate an initial pressure between six pounds per square inch and seven pounds per square inch.

According to an exemplary embodiment, a residual pressure of the bottle is approximately zero after the cooling step.

According to an exemplary embodiment a bottle includes a first body portion having a circular cross-section and a second body portion having a non-circular cross-section. The second body portion has a portion length that is at least thirty five percent of a total length of the bottle. The non-circular cross-section is configured to expand to a circular cross-section.

The foregoing has broadly outlined some of the aspects and features of the various embodiments, which should be construed to be merely illustrative of various potential applications of the disclosure. Other beneficial results can be obtained by applying the disclosed information in a different manner or by combining various aspects of the disclosed embodiments. Accordingly, other aspects and a more comprehensive understanding may be obtained by referring to the detailed description of the exemplary embodiments taken in conjunction with the accompanying drawings, in addition to the scope defined by the claims.

### BRIEF DESCRIPTION OF THE DRAWINGS

FIG. 1 is a perspective view of an exemplary container.

FIG. 2 is a side elevational view of the container of FIG. 1.

FIG. 3 is another side elevational view of the container of FIG. 1.

FIG. 4 is a top plan view of the container of FIG. 1.

FIG. 5 is a bottom plan view of the container of FIG. 1.

FIG. 6 is a schematic illustration of an exemplary warm-fill process using the container of FIGS. 1-5.

FIG. 7 is a flow diagram of the warm-fill process of FIG. 6.

FIGS. 8-10 are cross sectional views of the container of FIGS. 1-5 during steps of the warm-fill process of FIG. 6.

The drawings are only for purposes of illustrating preferred embodiments and are not to be construed as limiting the disclosure. Given the following enabling description of the drawings, the novel aspects of the present disclosure should become evident to a person of ordinary skill in the art. This detailed description uses numerical and letter designations to refer to features in the drawings. Like or similar designations in the drawings and description have been used to refer to like or similar parts of embodiments.

### DETAILED DESCRIPTION

As required, detailed embodiments are disclosed herein. It must be understood that the disclosed embodiments are merely exemplary of various and alternative forms. As used herein, the word “exemplary” is used expansively to refer to embodiments that serve as illustrations, specimens, models, or patterns. The figures are not necessarily to scale and some features may be exaggerated or minimized to show details of particular components. In other instances, well-known components, systems, materials, or methods that are known to those having ordinary skill in the art have not been described in detail in order to avoid obscuring the present disclosure. Therefore, specific structural and functional details disclosed herein are not to be interpreted as limiting, but merely as a basis for the claims and as a representative basis for teaching one skilled in the art.

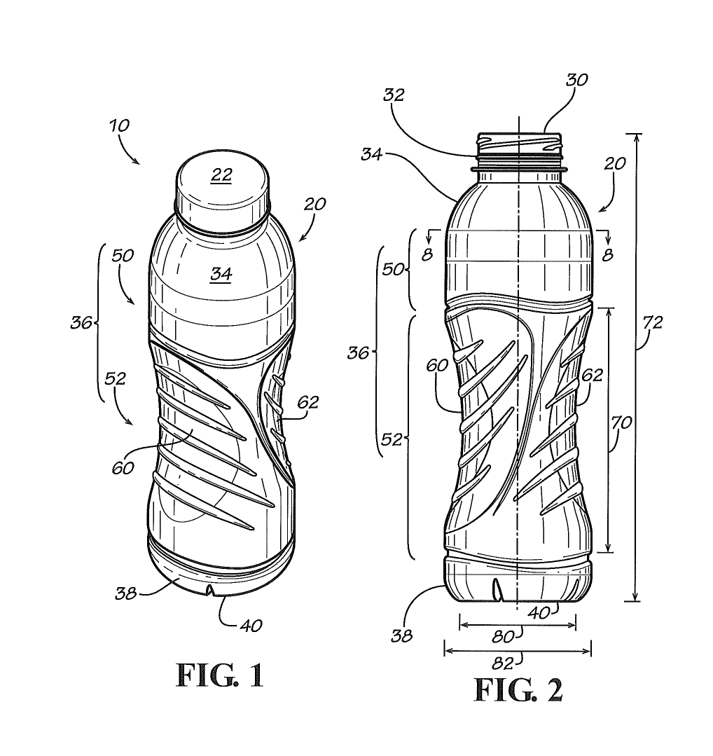

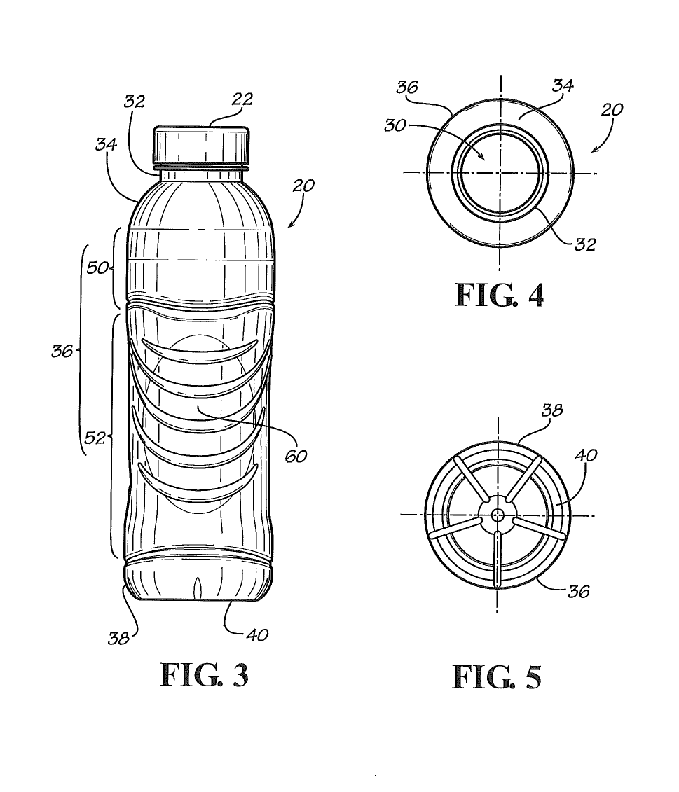

FIGS. 1-5 illustrate an exemplary embodiment of a container 10. The container 10 includes a bottle 20 and a closure 22. The bottle 20 includes an orifice 30, neck 32, shoulder 34, a body or sidewall 36, a heel 38, and a base 40. For example, the neck 32 has a neck finish of thirty eight millimeters and a one hundred eighty degree thread length.

The sidewall 36 includes a circular portion 50 and a non-circular portion 52. Referring momentarily to FIG. 8, the circular portion 50 has a circular cross-section and the non-circular portion 52 has an expandable non-circular cross section. Continuing with FIGS. 1-5, the non-circular portion 52 is configured to provide a target for the user to grip the container 10 at an ergonomically desirable location. For example, gripping the bottle 20 at the non-circular portion 52 facilitates pouring from the bottle 20 through the orifice 30. The non-circular portion 52 also facilitates squeezing the bottle 20 to dispense a product through the orifice 30, as described in further detail below.

The non-circular portion 52 is a flexible portion. The illustrated non-circular portion 52 is oval-shaped and includes a first main panel 60 and a second main panel 62, each represented by opposed long sides of an oval. The oval-shaped cross section of the non-circular portion 52 facilitates drinking from the bottle 20 by squeezing the first main panel 60 and the second main panel 62 together to force liquid out of the bottle 20. In addition, as described in further detail below and shown in FIG. 9, the non-circular portion 52 is configured to expand outwardly, from an oval-shaped cross section to a substantially circular cross section, as pressure increases during a filling process and then return to the oval-shaped cross section as the pressure later decreases (e.g., as shown in FIG. 10).

In alternative embodiments, the non-circular portion is triangular-shaped, square-shaped, or shaped as another polygon or shape that is non-circular.

Referring to FIG. 2, in certain embodiments, a surface area of the non-circular portion 52 is greater than thirty percent of a total surface area of the bottle 20. In certain embodiments, a length 70 of the non-circular portion 52 is at least thirty-five percent of a length 72 of the bottle 20.

The base 40 is flat. For example, the base 40 has a very low petaloid profile. The base 40 is not required to be footed due to the lower initial pressure that is facilitated by the flexible non-circular portion 52. In certain embodiments, the base 40 includes a standing diameter 80 that at is least seventy percent of an outer diameter 82 of the bottle 20. The standing diameter 80—defines the outer edge of an area of a standing surface. The standing surface is that which is in contact with another planar surface when base 40 rests on the planar surface. In certain embodiments, the area of the standing surface is greater than fifty percent of a cross-sectional area defined by the outer diameter 82.

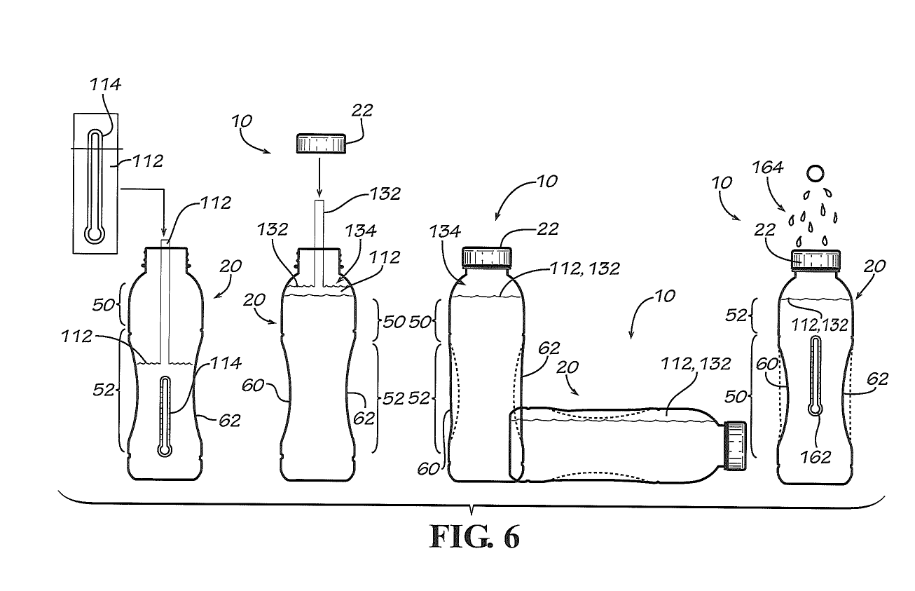

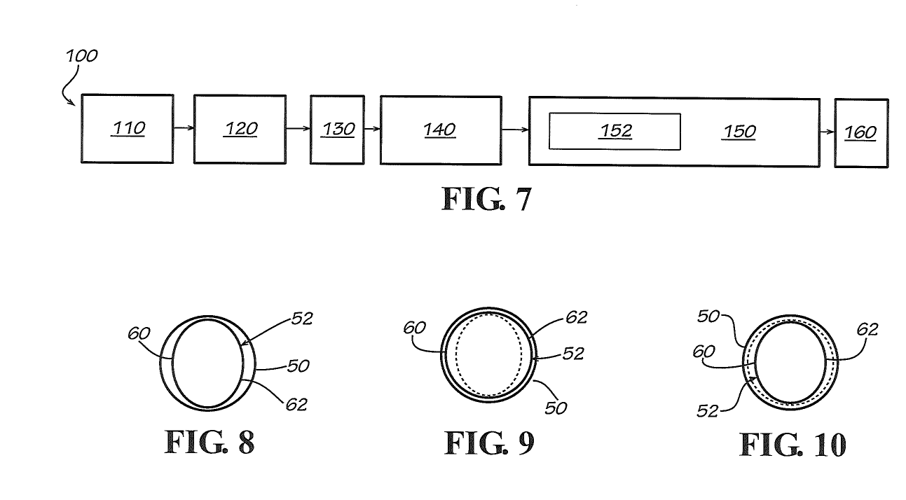

Referring to FIGS. 6-8, a process 100 is now described. FIG. 6 is a schematic illustration of the process 100, FIG. 7 illustrates a flow chart of the process 100, and FIGS. 8-10 illustrates the cross-sections of the circular portion 50 and the non-circular portion 52 during the process 100.

In certain embodiments, the process 100 uses a product 112 (e.g., liquids) that is a shelf-stable sensitive beverage without preservatives. For example, the product 112 has a pH of less than or equal to 4.2. The process 100 is performed in a filler room with air quality at a minimum of ISO 7/Class 10,000. The filler room has a positive pressure with 25 air changes per hour.

Because the filling temperature of the process 100 is below seventy eight degrees Celsius, the container 10 is not exposed to temperatures at or above a glass transition temperature at which a PET material becomes soft and capable of permanent deformation. As such, the container 10 does not need to include a heavy heat-set PET bottle. For example, heavy heat-set PET bottles include a special resin and are formed according to a high energy blow-molding process. Rather, the container 10 can include a lighter weight bottle and use a standard PET resin. Also, a blow-molding process that is used to form the bottle 20 is a relatively low-energy process that does not require air flushing or hot moulds.

In addition, lower product processing temperatures result in less package distortion and lower in-pack vacuum. As such, the container 10 has greater design flexibility and lighter pack weight.

According to a heating step 110, the product 112 (e.g., a liquid such as a beverage) is heated to a first temperature 114 that is between about seventy degrees Celsius and seventy seven degrees Celsius. In certain embodiments, the first temperature 114 is between about seventy two degrees Celsius and seventy four degrees Celsius. In certain embodiment, the first temperature 114 is below seventy degrees Celsius. However, a temperature lower than seventy degrees Celsius will require a relatively long holding time that is not operationally friendly.

According to a filling step 120, the bottle 20 is filled with the product 112. Initially, the product 112 is at the first temperature 114 due to the heating step 110. Referring to FIG. 8, the non-circular portion 52 is oval-shaped as it is when the bottle 20 is empty (i.e., with little or no internal pressure applied).

According to a dosing step 130, a small amount of liquid nitrogen 132 is added to the headspace 134 of the container 10. The liquid nitrogen 132 drop provides an initial internal pressure at the time of filling/capping (e.g., after a capping step) and offsets the vacuum created by displacement when the product 112 cools down during a cooling step.

For example, the amount of liquid nitrogen 132 is selected to provide an initial pressure of between about six pounds per square inch (psi) and twenty psi, between ten psi and twelve psi, or between six psi and seven psi.

According to a capping step 140, the bottle 20 is capped with the closure 22 to secure the product 112 in the container 10. For example, the closure 22 is a cold-fill one-piece high-density polyethylene (HDPE) flat closure or a cold-fill HDPE three-piece sport closure.

The non-circular portion 52 is a controlled, expandable design feature of the bottle 20. Referring to FIG. 9, after the bottle 20 is capped with the closure 22, the liquid nitrogen 132 creates an initial internal pressure in the container 10 that causes the non-circular portion 52 to flex and become circle-shaped. As such, the structure of the non-circular portion 52 absorbs the initial pressure and thus lowers the initial pressure on the other portions of the container 10 including the closure 22, the neck 32, and the base 40. Alternatively described, the volume of the bottle 20 increases at the non-circular portion 52 of the bottle 20 to absorb the initial pressure from the liquid nitrogen 132. Because the increase in volume minimizes the internal pressure, less pressure is applied to the neck 32, the closure 22, and the base 40. Thus, certain design limitations on the neck 32, the closure 22, and the base 40 are removed.

According to a holding step 150, the capped container 10 is held for at least three hundred seconds (i.e., five minutes) before a cooling step 160. During the holding step 150, according to an inversion step 152, the container 10 is inverted for at least twenty seconds. The inversion step 152 is performed to sterilize the closure 22.

Referring to FIGS. 6 and 7, according to a cooling step 160, the container 10 is cooled to a second temperature 162 (e.g., with a cold spray 164). Referring to FIG. 10, as the product 112 cools, the volume of the product 112 decreases. The volume displacement creates a vacuum and the internal pressure decreases. The pressure drop is offset as the non-circular portion 52 returns to an oval-shape and the volume of the bottle 20 at the non-circular portion 52 decreases. The non-circular portion 52 is biased towards and oval shape and thus returns to that shape as the internal pressure decreases from the initial internal pressure.

As an example, the container 10 has a nominal volume of six hundred milliliters, a brimful volume of six hundred fifty three milliliters, a weight of twenty five and a half grams, a thirty eight millimeter finish, an outer diameter of seventy millimeters, and a height of two hundred twenty one millimeters. During the process 100, the container 10 has internal pressure variation including an initial pressure of 6.15 pounds per square inch (psi) at a temperature of seventy five degrees Celsius, a pressure of 1.38 psi at a temperature of thirty five degrees Celsius, a pressure of 0.42 psi at twenty degrees Celsius, and a pressure of zero psi at four degrees Celsius. The initial filling pressure (e.g., the amount of nitrogen to use) is selected to bring the container 10 to zero pressure after cooling (e.g., the residual pressure at the end of the process). The lower initial pressure is facilitated by the flexible non-circular portion 52. For example, an initial pressure of a similar container with a circular cross-section throughout is eight psi. Thus, the non-circular portion 52 can reduce the initial pressure of a container by at least twenty three percent.

This written description uses examples to disclose the subject matter and to enable any person skilled in the art to practice the subject matter, including making and using any devices or systems and performing any incorporated methods. The patentable scope is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claims is:

1. A process, comprising:
filling a bottle with a liquid, wherein the liquid is initially at a temperature between about seventy degrees Celsius and seventy seven degrees Celsius.
adding a dose of liquid nitrogen to the liquid in the bottle, wherein the dose of liquid nitrogen is selected to generate an initial pressure to expand a portion of the bottle having a non-circular cross-section, wherein the portion has a portion length that is at least thirty five percent of a total length of the bottle;
capping the bottle with a closure;
inverting the bottle for a minimum inverting time; and
cooling the bottle after a minimum holding time.

2. The process of claim 1, wherein the temperature of the liquid is between about seventy two degrees Celsius and seventy four degrees Celsius.

3. The process of claim 1, wherein the dose of liquid nitrogen is selected to generate an initial pressure between six pounds per square inch and twenty pounds per square inch.

4. The process of claim 1, wherein the dose of liquid nitrogen is selected to generate an initial pressure between six pounds per square inch and seven pounds per square inch.

5. The process of claim 1, wherein the minimum inverting time is twenty seconds and the minimum holding time is three hundred seconds.

6. The process of claim 1, wherein the non-circular cross-section is oval-shaped, square-shaped, or triangle-shaped.

7. The process of claim 1, wherein the portion is configured to expand after the capping step.

8. The process of claim 7, wherein the portion is configured to contract during the holding step, the inverting step, and the cooling step.

9. The process of claim 7, wherein the portion is configured to expand so as to have a circular cross-section.

10. The process of claim 1, wherein a residual pressure of the bottle is approximately zero after the cooling step.

11. The process of claim 1, wherein the bottle includes a low profile base or a petaloid base.

12. The process of claim 11, wherein the base includes a standing diameter that is greater than seventy percent of an outside diameter of the bottle.

13. The process of claim 11, wherein the base includes a standing surface, wherein the standing surface has an area that is greater than fifty percent of an area defined by an outside diameter of the bottle.

14. The process of claim 1, wherein the portion includes a portion surface area, wherein the portion surface area is greater than thirty percent of a bottle surface area of the bottle.

15. A process, comprising:
filling a bottle with a liquid, wherein the liquid is initially at a temperature between about seventy degrees Celsius and seventy seven degrees Celsius.
adding a dose of liquid nitrogen to the liquid in the bottle, wherein the dose of liquid nitrogen is selected to generate an initial pressure between six pounds per square inch and twenty pounds per square inch; and.
capping the bottle with a closure.

16. The process of claim 15, further comprising inverting the bottle for a minimum of twenty seconds; and cooling the bottle after a minimum holding time of three hundred seconds.

17. The process of claim 16, wherein the temperature of the liquid is between about seventy two degrees Celsius and seventy four degrees Celsius.

18. The process of claim 16, wherein the dose of liquid nitrogen is selected to generate an initial pressure between six pounds per square inch and seven pounds per square inch.

19. The process of claim 16, wherein a residual pressure of the bottle is approximately zero after the cooling step.

20. A bottle, comprising:
a first body portion having a circular cross-section; and
a second body portion having a non-circular cross-section, wherein the second body portion has a portion length that is at least thirty five percent of a total length of the bottle, and wherein the non-circular cross-section is configured to expand to a circular cross-section.
